(19) United States
(12) Patent Application Publication
(10) Pub. No.: US 2026/0022592 A1
(43) Pub. Date: Jan. 22, 2026

(54) Handle Assembly and Method for Controlling Same

(71) Applicant: Illinois Tool Works Inc., Glenview, IL (US)

(72) Inventor: Penghui Yi, Shanghai (CN)

(21) Appl. No.: 19/263,706

(22) Filed: Jul. 9, 2025

(30) Foreign Application Priority Data
Jul. 16, 2024 (CN) 202410955986.1

(51) Int. Cl. E05B 81/76; E05B 85/10

(52) U.S. Cl. CPC E05B 81/77; E05B 85/103

(57) ABSTRACT

A handle assembly and a method for controlling a handle assembly. The handle assembly includes a base, a detection device, a handle, a detected component and a control device. The base defines a base cavity. The detection device is disposed in the base. The handle is movable relative to the base. The detected component is disposed in the handle. The control device is communicatively connected to the detection device. The detection device is configured to detect a distance between the detected component and the detection device and to send a detected distance value to the control device, the control device is configured to send different signals according to the distance value detected by the detection device. The handle assembly is capable of determining the current position of the handle from the position relationship of the detection device and the detected device. Furthermore, the handle assembly is capable of detecting the positions of the detected device and the hand simultaneously, thereby controlling the handle, which helps the user to drive the handle without touching a handle body, thereby improving user convenience.

### RELATED APPLICATION

The present application claims the benefit of Chinese Patent Application No. 202410955986.1, filed Jul. 16, 2024, titled “Handle Assembly and Method for Controlling Same,” the contents of which are hereby incorporated by reference.

### BACKGROUND

The present disclosure relates to the field of handles. In the prior art, a handle assembly is arranged on a vehicle sheet metal. The handle assembly is flush with the vehicle sheet metal, and a handle is movable relative to the vehicle sheet metal. However, the handle requires control from a vehicle owner to rotate relative to the vehicle sheet metal and open.

### SUMMARY

The present disclosure relates generally to a handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a handle assembly mounted on a vehicle sheet metal according to the present disclosure.

FIG. 1B is a lateral cross-sectional view of the handle assembly shown in FIG. 1A that is mounted on a vehicle sheet metal.

FIG. 1C is a cross-sectional view of the handle assembly shown in FIG. 1A that is mounted on a vehicle sheet metal, taken along line A-A in FIG. 1B.

FIG. 2 is a lateral cross-sectional view of the handle assembly mounted on a vehicle sheet metal with a handle in a deployed position according to the present disclosure.

FIG. 3 is a lateral cross-sectional view of the handle assembly mounted on a vehicle sheet metal with the handle in an unlocked position according to the present disclosure.

FIGS. 4-7 are lateral cross-sectional views of the handle assembly mounted on a vehicle sheet metal with a human hand and the handle in different positions.

FIG. 8 is an illustrative view of an internal structure of a control device shown in FIG. 1B.

FIG. 9 is a control flow chart of a first embodiment of a procedure for controlling the handle assembly described above.

FIG. 10 is a control flow chart of an embodiment of step 908 shown in FIG. 9.

FIG. 11 is a control flow chart of a second embodiment of a procedure for controlling the handle assembly described above.

FIG. 12 is a control flow chart of an embodiment of step 1110 shown in FIG. 9.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

This disclosure aims to provide a simpler screw A first aspect of the present disclosure provides a handle assembly, it comprises a base, a detection device, a handle, a detected component and a control device. The base defines a base cavity. The detection device is disposed in the base. The handle is movable relative to the base. The detected component is disposed in the handle. The control device is communicatively connected to the detection device. The detection device is configured to detect a distance between the detected component and the detection device and to send a detected distance value to the control device, the control device is configured to send different signals according to the distance value detected by the detection device.

The handle assembly according to the above first aspect, the control device is configured such that:
when the distance between the detected component and the detection device detected by the detection device is equal to a first handle distance, the control device sends a closed position signal;
when the distance between the detected component and the detection device detected by the detection device is less than or equal to a second handle distance and greater than the first handle distance, the control device sends an open position signal; and/or
when the distance between the detected component and the detection device detected by the detection device is greater than the second handle distance, the control device sends an unlocked position signal. The first handle distance is less than the second handle distance.

The handle assembly according to the above first aspect, the detection device is configured to detect a distance between a human hand and the detection device and to send a detected distance value to the control device. The control device is configured to send different handle assembly control signals according to the distance between the detected component and the detection device and the distance between the human hand and the detection device which are detected by the detection device.

The handle assembly according to the above first aspect, the control device is configured such that:
when the distance between the detected component and the detection device detected by the detection device is equal to the first handle distance and the distance between the human hand and the detection device detected by the detection device is less than a first human hand distance and greater than the first handle distance, the control device sends a handle opening signal;
when the distance between the detected component and the detection device detected by the detection device is less than or equal to the second handle distance and greater than the first handle distance and the distance between the human hand and the detection device detected by the detection device is less than or equal to a second human hand distance and greater than the second handle distance, the control device sends a handle closing signal;
when the distance between the detected component and the detection device detected by the detection device is less than or equal to the second handle distance and greater than the first handle distance and the distance between the human hand and the detection device detected by the detection device is less than the distance between the detected component and the detection device, the control device sends an anti-pinch signal; and/or
when the distance between the detected component and the detection device detected by the detection device is greater than the second handle distance and the distance between the human hand and the detection device detected by the detection device is less than the distance between the detected component and the detection device, the control device sends a door unlock position signal;
the first handle distance is less than the second handle distance, and the first human hand distance is less than the second human hand distance.

The handle assembly according to the above first aspect, it further comprises a handle actuating device configured to drive the handle to move relative to the base and being communicatively connected to the control device. The control device is configured to control the handle actuating device to activate or deactivate according to the different handle assembly control signals.

The handle assembly according to the above first aspect, the control device is configured such that:
when the control device sends the handle opening signal, the control device activates the handle actuating device to move the handle away from the base;
when the control device sends the handle closing signal, the control device activates the handle actuating device to move the handle close to the base;
when the control device sends the anti-pinch signal, the control device deactivates the handle actuating device to allow the handle to hold in the current position, or the control device activates the handle actuating device to move the handle away from the base.

The handle assembly according to the above first aspect, it further comprises an unlocking device configured to be capable of unlocking a door and communicatively connecting to the control device. The control device is configured to activate the unlocking device when the control device sends the door unlock position signal.

The handle assembly according to the above first aspect, the detection device detects the distance based on electromagnetic waves, the detection device comprises a millimeter-wave radar. The detected component is made of metal. The base and the handle are made of a non-metallic material, the non-metallic material includes plastic.

A second aspect of the present disclosure provides a method for controlling a handle assembly, comprising the following steps:
obtaining a distance between a human hand and a detection device;
obtaining a distance between a handle and the detection device;
sending different handle assembly control signals according to the obtained distance between the human hand and the detection device and the obtained distance between the handle and the detection device.

The method for controlling a handle assembly according to the above second aspect, when the distance between a detected component and the detection device detected by the detection device is equal to a first handle distance, the handle is in a closed position. When the distance between the detected component and the detection device detected by the detection device is equal to a second handle distance, the handle is in an open position. When the distance between the detected component and the detection device detected by the detection device is greater than the second handle distance, the handle is in an unlocked position. The procedure of sending different handle assembly control signals according to the obtained distance between the human hand and the detection device and the obtained distance between the handle and the detection device comprises the following steps:
when the distance between the detected component and the detection device detected by the detection device is equal to the first handle distance and the distance between the human hand and the detection device detected by the detection device is less than a first human hand distance and greater than the first handle distance, sending a handle opening signal by the control device to activate a handle actuating device to open the handle;
when the distance between the detected component and the detection device detected by the detection device is less than or equal to the second handle distance and greater than the first handle distance and the distance between the human hand and the detection device detected by the detection device is less than or equal to a second human hand distance and greater than the second handle distance, sending a handle closing signal by the control device to activate the handle actuating device to close the handle;
when the distance between the detected component and the detection device detected by the detection device is less than or equal to the second handle distance and greater than the first handle distance and the distance between the human hand and the detection device detected by the detection device is less than the distance between the detected component and the detection device, sending an anti-pinch signal by the control device to deactivate the handle actuating device such that the handle holds in the current position or to activate the handle actuating device such that the handle moves away from the base; and/or
when the distance between the detected component and the detection device detected by the detection device is greater than the second handle distance and the distance between the human hand and the detection device detected by the detection device is less than the distance between the detected component and the detection device, sending a door unlock position signal by the control device to activate an unlocking device.

The handle assembly of the present disclosure is capable of determining the current position of the handle from the position relationship of the detection device and the detected device. Furthermore, the handle assembly of the present disclosure is capable of detecting the positions of the detected device and the hand simultaneously, thereby controlling the handle, which helps the user to drive the handle without touching a handle body, thereby improving user convenience.

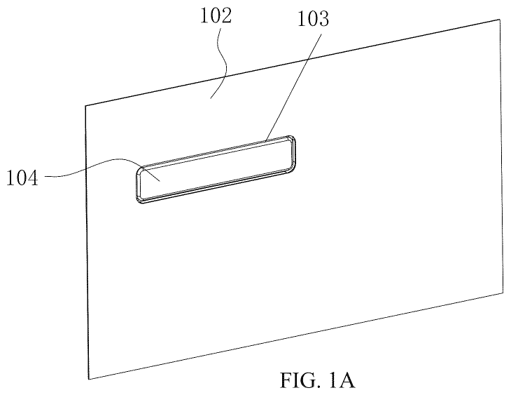

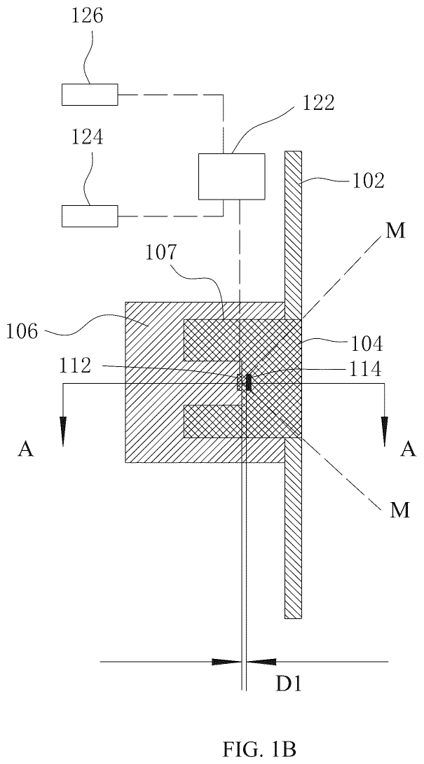

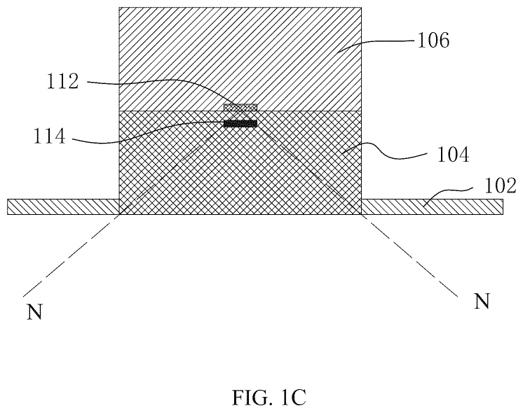

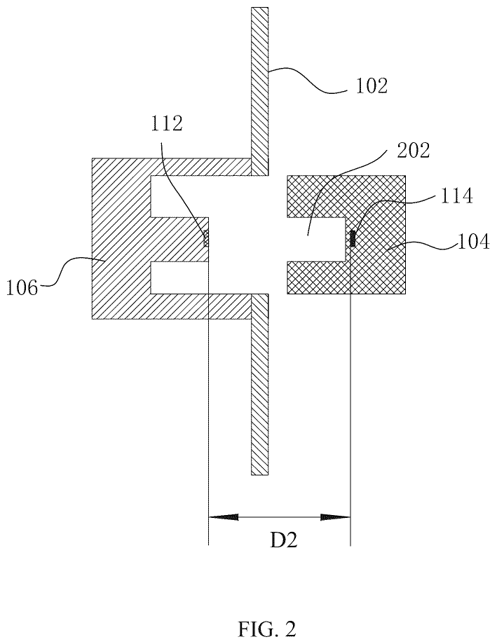

FIG. 1A is a perspective view of a handle assembly mounted on a vehicle sheet metal according to the present disclosure. As shown in FIG. 1A, the handle assembly is mounted to a vehicle sheet metal 102. A sheet metal through hole 103 is provided in the vehicle sheet metal 102, the sheet metal through hole extends through a thickness of the vehicle sheet metal 102. The handle assembly includes a handle 104. The handle 104 is disposed in the sheet metal through hole 103, is movable relative to the vehicle sheet metal 102, and has a hidden position, a deployed position and an unlocked position. When the handle 104 is in the hidden position, a surface of the handle 104 is flush with a surface of the vehicle sheet metal 102. When the handle 104 is in the deployed position, an accommodating space 202 is formed between the handle 104 and the vehicle sheet metal 102 (with reference to FIG. 2), thereby allowing a human hand to enter the accommodating space 202 and pull the handle 104 to the unlocked position. When the handle 104 is in the unlocked position, the handle 104 triggers unlocking device to unlock a door (e.g., a vehicle door, not shown).

FIG. 1B is a lateral (i.e., vertical) cross-sectional view of the handle assembly shown in FIG. 1A that is mounted on the vehicle sheet metal. As shown in FIG. 1B, the handle assembly further includes a base 106, a detection device 112, a detected component 114, and a control device 122. The base 106 is arranged on a side of the vehicle sheet metal 102. The base 106 defines a base cavity 107 for accommodating the handle 104. The detection device 112 is disposed in the base 106. The detected component 114 is disposed in the handle 104. Since a distance between the handle 104 and the base 106 changes during the movement of the handle 104 relative to the base 106, a distance between the detection device 112 and the detected component 114 changes accordingly. The control device 122 is communicatively connected to the detection device 112. The detection device 112 is configured to detect the distance between the detection device 112 and the detected component 114 and to send a measured distance value to the control device 122. The control device 122 is configured to send different signals based on the measured distance value.

As shown in FIG. 1B, when the handle 104 is in the hidden position, the distance between the detection device 112 and the detected component 114 is a first handle distance D1. The control device 122 is configured such that: when the control device 122 receives a signal from the detection device 112 that the distance between the detection device 112 and the detected component 114 is equal to the first handle distance D1, the control device 122 determines that the handle 104 is in the hidden position and sends a closed position signal.

As shown in FIG. 1B, the handle assembly further includes a handle actuating device 124 and an unlocking device 126. The handle actuating device 124 is communicatively connected to the control device 122. The handle actuating device 124 is configured to drive the movement of the handle 104 relative to the base 106 between the hidden position and the deployed position. As an example, the handle actuating device 124 is a motor that is capable of pushing and pulling the handle 104 to move relative to the base 106. The control device 122 is configured to control the handle actuating device 124 to activate and deactivate according to different handle assembly control signals, thereby actuating the handle 104. The unlocking device 126 is communicatively connected to the control device 122. The unlocking device 126 is configured to unlock a door (e.g., a vehicle door). The control device 122 is configured to activate an unlocking device 126 when the control device 122 sends a door unlocking position signal.

FIG. 1C is a cross-sectional view of the handle assembly shown in FIG. 1A that is mounted on a vehicle sheet metal, taken along line A-A (i.e., horizontally) in FIG. 1B. As shown in FIGS. 1B-1C, the detection device 112 may be configured to have a certain recognition area. In the present disclosure, the detection device 112 is configured to detect a fan-shaped area (bounded by a dashed line M-M in FIG. 1B) in a horizontal direction and a fan-shaped area (bounded by a dashed line N-N in FIG. 1B) in a vertical direction, both taking the detection device 112 as an origin. The bounded range includes the entire area which the handle 104 can cover when it moves relative to the base 106, thereby ensuring that the detected component 114 remains within a detection area of the detection device 112.

FIG. 2 is a lateral (i.e., vertical) cross-sectional view of the handle assembly mounted on a vehicle sheet metal with the handle 104 in a deployed position according to the present disclosure. As shown in FIG. 2, when the handle 104 is in the deployed position, the distance between the detection device 112 and the detected component 114 is a second handle distance D2. The first handle distance D1 is less than the second handle distance D2. The control device 122 is also configured such that: when the control device 122 receives a signal from the detection device 112 that the distance between the detection device 112 and the detected component 114 is less than or equal to the second handle distance D2 and greater than the first handle distance D1, the control device 122 sends an open position signal, which indicates that the handle 104 is in an open status (i.e., not flush with the vehicle sheet metal). The control device 122 is also configured such that: when the control device 122 receives a signal from the detection device 112 that the distance between the detection device 112 and the detected component 114 is greater than the second handle distance D2, the control device 122 sends an unlocking position signal, which indicates that the handle 104 is being pulled by a user and is expected to be unlocked.

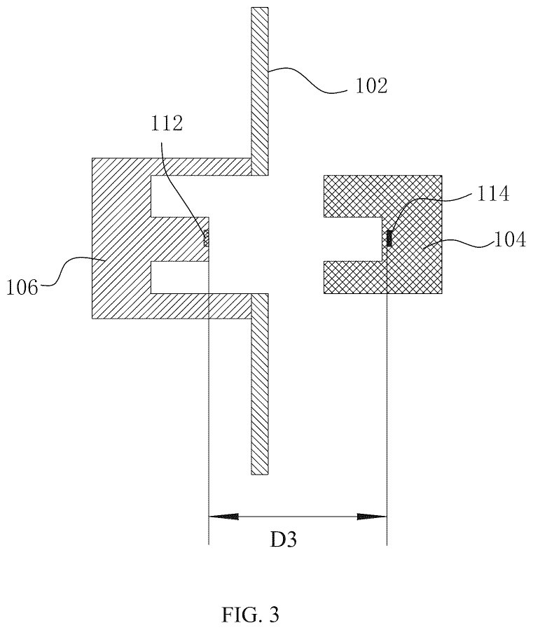

FIG. 3 is a lateral (i.e., vertical) cross-sectional view of the handle assembly mounted on a vehicle sheet metal with the handle 104 in an unlocked position according to the present disclosure. As shown in FIG. 3, when the handle 104 is in the unlocked position, the distance between the detection device 112 and the detected component 114 is a third handle distance D3. The second handle distance D2 is less than the third handle distance D3.

In addition, the detection device 112 of the present disclosure is also configured to detect a distance between a human hand and the detection device 112 and to send a measured distance value to the control device 122. In other words, the detection device 112 is configured to detect distances from the detection device to a plurality of target objects. As an embodiment, the detection device 112 detects the distances based on electromagnetic waves. The detected component 114 is made of metal. The base 106 and the handle 104 are made of a non-metallic material and thus are not detectable by the detection device 112. For example, the non-metallic material is plastic. As an embodiment, the detection device 112 is a millimeter-wave radar. The millimeter-wave radar is capable of penetrating thin, low-density, or low-conductivity metals to detect target objects behind the metals.

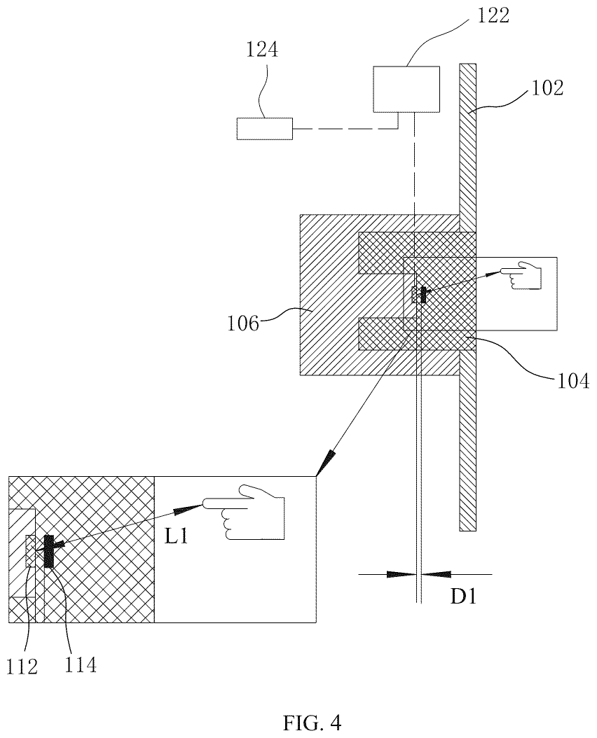

FIGS. 4-7 are lateral (i.e., vertical) cross-sectional views of the handle assembly mounted on the vehicle sheet metal with the human hand and the handle 104 in different positions. Referring to FIGS. 4-7, the following describes that the detection device 112 sends different handle assembly control signals based on the distances between the detected component 114 and the detection device 112, and between the human hand and the detection device 112, both detected by the detection device 112.

As shown in FIG. 4, the control device 122 is configured such that: when the distance between the detected component 114 and the detection device 112 detected by the detection device 112 is equal to the first handle distance D1 and the distance between the human hand and the detection device 112 detected by the detection device 112 is less than a first human hand distance L1 and greater than the first handle distance D1, the detection device 112 sends a handle opening signal. The control device 122 activates the handle actuating device 124 based on the received handle opening signal to move the handle 104 away from the base 106. In other words, when the handle 104 is in the hidden position and the human hand is close to the handle 104, the handle actuating device 124 is activated to move the handle 104 from the hidden position to the deployed position.

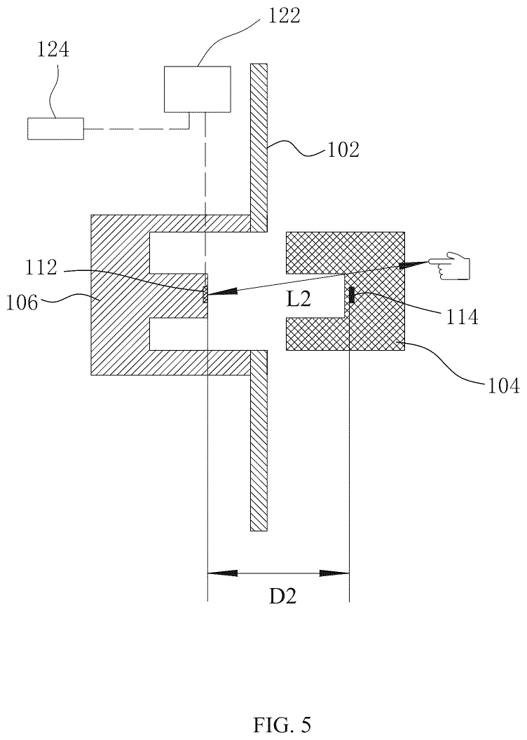

As shown in FIG. 5, the control device 122 is configured such that: when the distance between the detected component 114 and the detection device 112 detected by the detection device 112 is less than or equal to the second handle distance D2 and greater than the first handle distance D1 and the distance between the human hand and the detection device 112 detected by the detection device 112 is less than or equal to a second human hand distance L2 and greater than the second handle distance D2, the detection device 112 sends a handle closing signal. Herein, the first human hand distance L1 is less than the second human hand distance L2. The control device 122 activates the handle actuating device 124 according to the received handle closing signal to move the handle 104 close to the base 106. In other words, when the handle 104 is in the deployed position and the human hand is close to the handle 104, the handle actuating device 124 is activated to move the handle 104 from the deployed position to the hidden position.

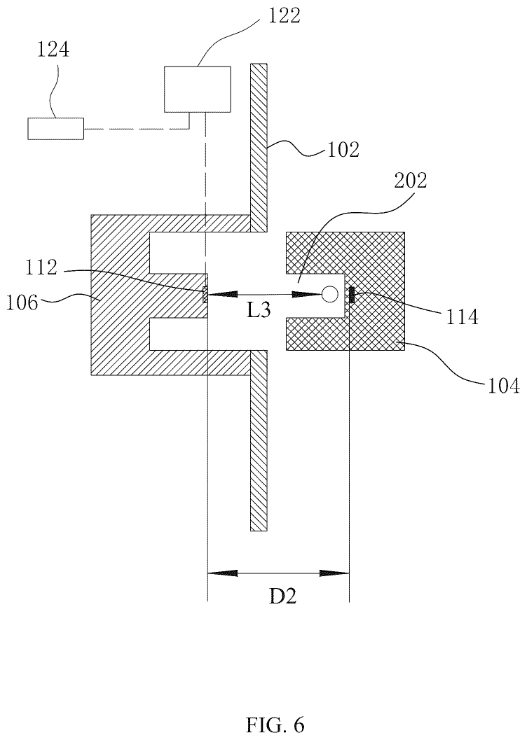

As shown in FIG. 6, the control device 122 is configured such that: when the distance between the detected component 114 and the detection device 112 detected by the detection device 112 is less than or equal to the second handle distance D2 and greater than the first handle distance D1 and the distance between the human hand and the detection device 112 detected by the detection device 112 is less than the distance between the detected component 114 and the detection device 112, the detection device 112 sends an anti-pinch signal. The control device 122 deactivates the handle actuating device 124 according to the received anti-pinch signal, such that the handle 104 holds in the current position, or the control device 122 activates the handle actuating device 124 to move the handle 104 away from the base 106. In other words, when the handle 104 is in either position between the hidden position and the deployed position, and the human hand is between the handle 104 and the base 106 (the human hand extends into the accommodating space 202), the handle actuating device 124 is deactivated, such that the handle 104 holds in the current position, or the handle actuating device 124 is activated to move the handle 104 from the hidden position to the deployed position, thus preventing the handle 104 from moving towards the hidden position and then pinching the user's hand.

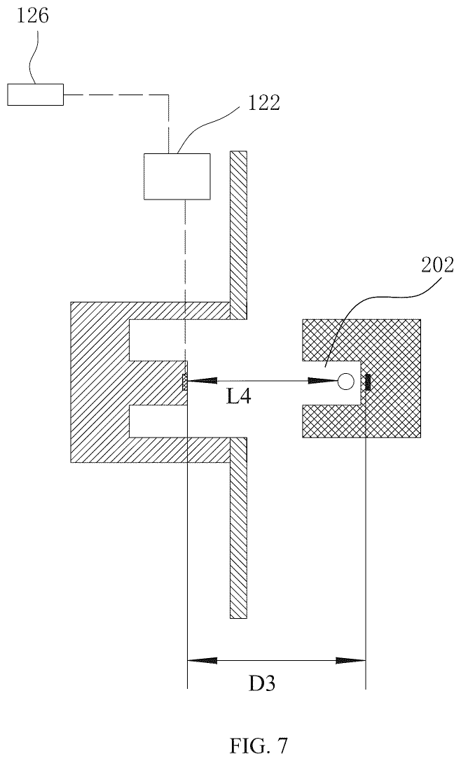

As shown in FIG. 7, the control device 122 is configured such that: when the distance between the detected component 114 and the detection device 112 detected by the detection device 112 is greater than the second handle distance D2 and the distance between the human hand and the detection device 112 detected by the detection device 112 is less than the distance between the detected component 114 and the detection device 112, the detection device 112 sends a door unlocking position signal. The control device 122 activates the unlocking device 126 based on the received door unlocking position signal. In other words, when the handle 104 is in the position such that the distance between the detected component 114 and the detection device 112 is greater than the second handle distance D2 and the human hand is positioned between the handle 104 and the base 106 (the human hand extends into the accommodating space 202), the unlocking device 126 is activated to unlock the vehicle door (not shown).

The handle assembly of the present disclosure is capable of determining the current position of the handle from the position relationship of the detection device and the detected device. Furthermore, the handle assembly of the present disclosure is capable of detecting the positions of the detected device and the hand simultaneously, thereby controlling the handle, which helps the user to drive the handle without touching a handle body, thereby improving user convenience.

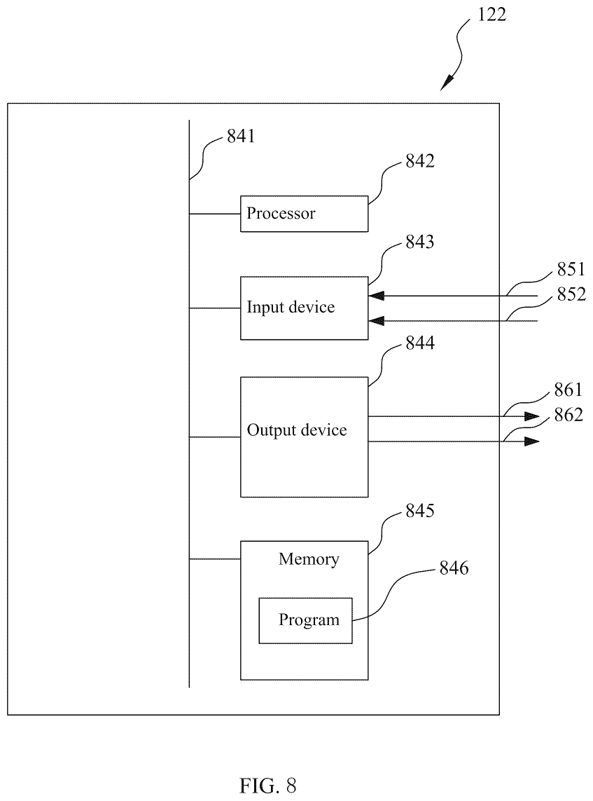

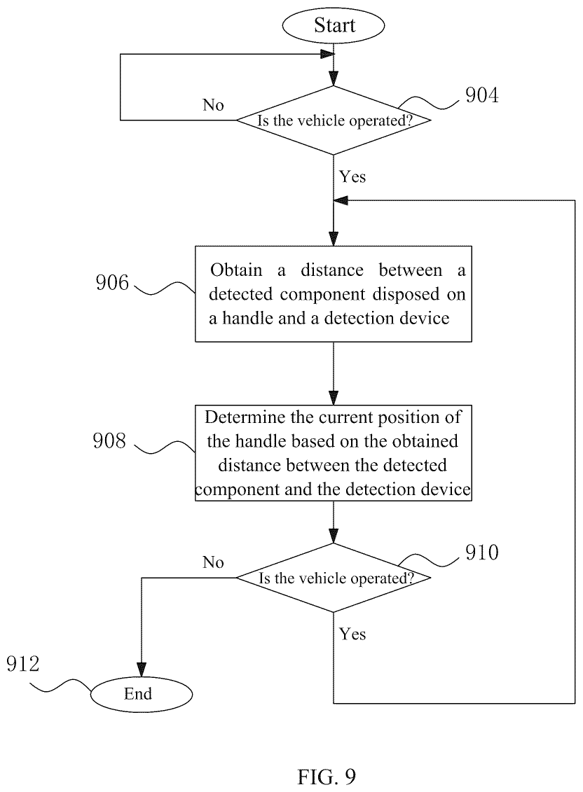

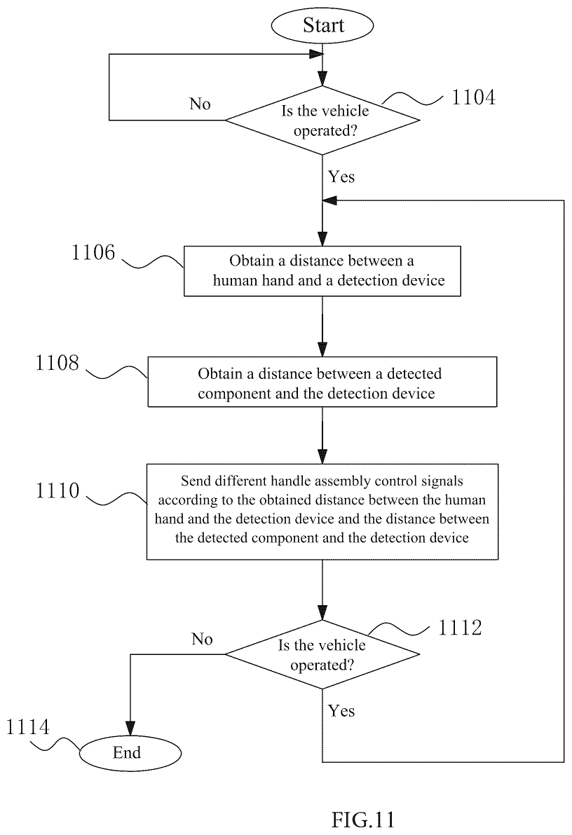

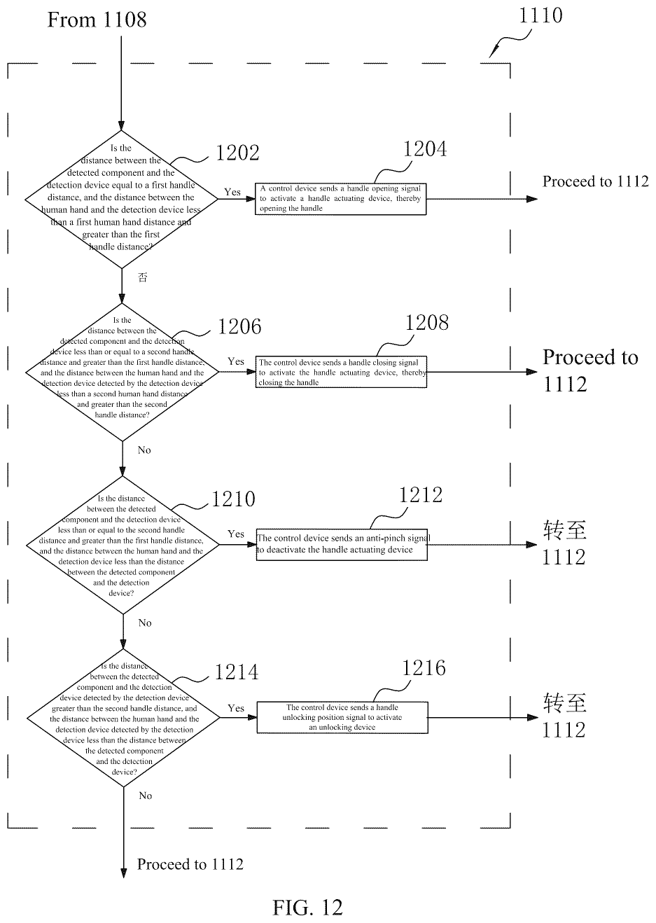

FIG. 8 is an illustrative view of an internal structure of the control device 122 shown in FIG. 1B. As shown in FIG. 8, the control device 122 includes a bus 841, a processor 842, an input device 843, an output device 844, and a memory 845 having a control program 846. The components in the control device 122, including the processor 842, the input device 843, the output device 844, and the memory 845, are communicatively connected to the bus 841, such that the processor 842 can control the operation of the input device 843, the output device 844 and the memory 845. Specifically, the memory 845 is configured to store programs, instructions and data, and the processor 842 reads the programs, instructions and data from the memory 845 and can write data to the memory 845. The processor 842 controls the operation of the input device 843 and the output device 844 by means of executing the programs and the instructions read from the memory 845. The input device 843 receives signals and data, including the distance between the detected component 114 and the detection device 112 detected by the detection device 112, the distance between the human hand and the detection device 112 detected by the detection device 112, and so on, through connection lines 851, 852. The output device 844 sends control signals via connection lines 861, 862 to the handle actuating device 124 and the unlocking device 126, thereby controlling the activation and deactivation of the handle actuating device 124 and the unlocking device 126. In an embodiment of the present disclosure, a program for implementing the flow chart shown in FIGS. 9-12 is stored in the memory 845 of the control device 122. The memory 845 can also store data such as the first handle distance D1, the second handle distance D2, the third handle distance D3, the first human hand distance L1, and the second human hand distance L2. As an example, the first handle distance D1 is 5 cm, the second handle distance D2 is 20 cm, the third handle distance D3 is 40 cm, the first human hand distance L1 is 30 cm, and the second human hand distance L2 is 45 cm.

It should be noted that the drawings in the present disclosure show the translation movement of the handle 104 relative to the base 106, but in other embodiments, the handle 104 may also be make rotation or other movement relative to the base 106, thereby achieving the hidden position, the deployed position and the unlocked position of the handle 104.

FIG. 9 is a control flow chart of a first embodiment of a procedure for controlling the handle assembly described above. As shown in FIG. 9, in step 904, the processor 842 determines whether the vehicle is operated. If the vehicle is not operated, the processor 842 returns the procedure to step 904, and if the vehicle is operated, the processor 842 proceeds the procedure to step 906.

In step 906, the processor 842 obtains the distance between the detected component 114 and the detection device 112. Subsequently, the processor 842 proceeds the procedure to step 908.

In step 908, the processor 842 sends different signals (e.g., a closed position signal, an open position signal, and an unlocking position signal) according to the obtained distance between the detected component 114 and the detection device 112. Different signals may be displayed on a display device (e.g., a vehicle display, a mobile phone, etc., which are not shown) by different graphics and/or colors, etc., so that the user (e.g., a vehicle owner) knows the current position of the handle 104. Subsequently, the processor 842 proceeds the procedure to step 910.

In step 910, the processor 842 determines whether the vehicle is still operated. If the vehicle is operated, the processor 842 returns the procedure to step 906. If the vehicle is not started, the processor 842 proceeds the procedure to step 912.

In step 912, the control program terminates.

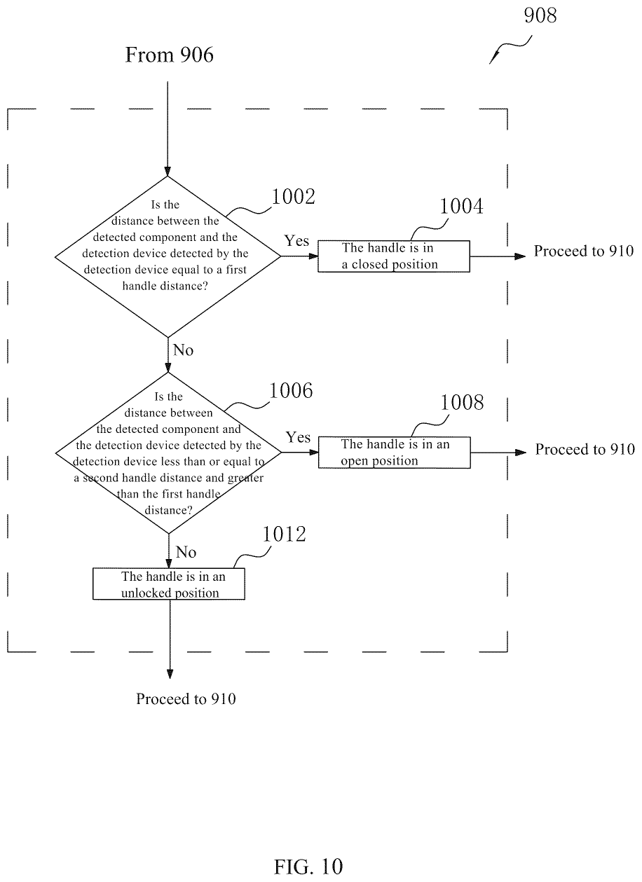

FIG. 10 is a control flow chart of an embodiment of step 908 shown in FIG. 9. As shown in FIG. 10, in step 1002, the processor 842 determines whether the distance between the detection device 112 and the detected component 114 is equal to the first handle distance D1. If the distance between the detection device 112 and the detected component 114 is equal to the first handle distance D1, the processor 842 proceeds the procedure to step 1004.

In step 1004, the control device 122 determines that the handle 104 is in the hidden position and sends a closed position signal. Subsequently, the processor 842 returns the procedure to step 910.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A handle assembly, comprising:
a base defining a base cavity;
a detection device disposed in the base;
a handle movable relative to the base;
a detected component disposed in the handle; and
a control device communicatively connected to the detection device;
wherein the detection device is configured to detect a distance between the detected component and the detection device and to send a detected distance value to the control device, and the control device is configured to send different signals according to the distance value detected by the detection device.

2. The handle assembly according to claim 1, wherein the control device is configured such that:
when the distance between the detected component and the detection device detected by the detection device is equal to a first handle distance, the control device sends a closed position signal;
when the distance between the detected component and the detection device detected by the detection device is less than or equal to a second handle distance and greater than the first handle distance, the control device sends an open position signal; and/or
when the distance between the detected component and the detection device detected by the detection device is greater than the second handle distance, the control device sends an unlocked position signal;
wherein the first handle distance is less than the second handle distance.

3. The handle assembly according to claim 2,
wherein the detection device is configured to detect a distance between a human hand and the detection device and to send a detected distance value to the control device; and
wherein the control device is configured to send different handle assembly control signals according to the distance between the detected component and the detection device and the distance between the human hand and the detection device which are detected by the detection device.

4. The handle assembly according to claim 3, wherein the control device is configured such that:
when the distance between the detected component and the detection device detected by the detection device is equal to the first handle distance and the distance between the human hand and the detection device detected by the detection device is less than a first human hand distance and greater than the first handle distance, the control device sends a handle opening signal;
when the distance between the detected component and the detection device detected by the detection device is less than or equal to the second handle distance and greater than the first handle distance and the distance between the human hand and the detection device detected by the detection device is less than or equal to a second human hand distance and greater than the second handle distance, the control device sends a handle closing signal;
when the distance between the detected component and the detection device detected by the detection device is less than or equal to the second handle distance and greater than the first handle distance and the distance between the human hand and the detection device detected by the detection device is less than the distance between the detected component and the detection device, the control device sends an anti-pinch signal; and/or
when the distance between the detected component and the detection device detected by the detection device is greater than the second handle distance and the distance between the human hand and the detection device detected by the detection device is less than the distance between the detected component and the detection device, the control device sends a door unlock position signal;
wherein the first handle distance is less than the second handle distance, and the first human hand distance is less than the second human hand distance.

5. The handle assembly according to claim 4, further comprising:
a handle actuating device being configured to drive the handle to move relative to the base and being communicatively connected to the control device;
wherein the control device is configured to control the handle actuating device to activate or deactivate according to the different handle assembly control signals.

6. The handle assembly according to claim 5, wherein the control device is configured such that:
when the control device sends the handle opening signal, the control device activates the handle actuating device to move the handle away from the base;
when the control device sends the handle closing signal, the control device activates the handle actuating device to move the handle close to the base; and
when the control device sends the anti-pinch signal, the control device deactivates the handle actuating device to allow the handle to hold in the current position, or the control device activates the handle actuating device to move the handle away from the base.

7. The handle assembly according to claim 4, further comprising:
an unlocking device configured to be capable of unlocking a door and communicatively connecting to the control device;
wherein the control device is configured to activate the unlocking device when the control device sends the door unlock position signal.

8. The handle assembly according to claim 1, wherein
the detection device detects the distance based on electromagnetic waves, and the detection device comprises a millimeter-wave radar;
the detected component is made of metal; and
the base and the handle are made of a non-metallic material, the non-metallic material includes plastic.

9. A method for controlling a handle assembly, comprising the following steps:
obtaining a distance between a human hand and a detection device;
obtaining a distance between a handle and the detection device; and
sending different handle assembly control signals according to the obtained distance between the human hand and the detection device and the obtained distance between the handle and the detection device.

10. The method for controlling a handle assembly according to claim 9, wherein when the distance between a detected component and the detection device detected by the detection device is equal to a first handle distance, the handle is in a closed position;
when the distance between the detected component and the detection device detected by the detection device is equal to a second handle distance, the handle is in an open position;
when the distance between the detected component and the detection device detected by the detection device is greater than the second handle distance, the handle is in an unlocked position; and
sending different handle assembly control signals according to the obtained distance between the human hand and the detection device and the obtained distance between the handle and the detection device comprises the following steps:
when the distance between the detected component and the detection device detected by the detection device is equal to the first handle distance and the distance between the human hand and the detection device detected by the detection device is less than a first human hand distance and greater than the first handle distance, sending a handle opening signal by the control device to activate a handle actuating device to open the handle;
when the distance between the detected component and the detection device detected by the detection device is less than or equal to the second handle distance and greater than the first handle distance and the distance between the human hand and the detection device detected by the detection device is less than or equal to a second human hand distance and greater than the second handle distance, sending a handle closing signal by the control device to activate the handle actuating device to close the handle;
when the distance between the detected component and the detection device detected by the detection device is less than or equal to the second handle distance and greater than the first handle distance and the distance between the human hand and the detection device detected by the detection device is less than the distance between the detected component and the detection device, sending an anti-pinch signal by the control device to deactivate the handle actuating device such that the handle holds in the current position or to activate the handle actuating device such that the handle moves away from the base; and
when the distance between the detected component and the detection device detected by the detection device is greater than the second handle distance and the distance between the human hand and the detection device detected by the detection device is less than the distance between the detected component and the detection device, sending a door unlock position signal by the control device to activate an unlocking device.
